(19) United States
(12) Patent Application Publication
(10) Pub. No.: US 2005/0090344 A1
(43) Pub. Date: Apr. 28, 2005

(54) Flexible tensioner arm with multiple hinges

(75) Inventors: Jeff Foster, Horseheads, NY (US); Mariano Garcia, Ithaca, NY (US)

Correspondence Address: BORGWARNER INC., POWERTRAIN TECHNICAL CENTER, 3800 AUTOMATION AVENUE, SUITE 100, AUBURN HILLS, MI, 48326-1782, US

(73) Assignee: BorgWarner Inc., Auburn Hills, MI (US)

(21) Appl. No.: 10/693,561

(22) Filed: Oct. 24, 2003

(51) Int. Cl. F16H 7/08; F16H 7/18

(52) U.S. Cl. 474/111; 474/140

(57) ABSTRACT

A multi-sectioned tensioner arm (60) is provided. The tensioner arm (60) includes a plurality of sections (62, 64, 66) with each section conjoined together via a link (68). each of the plurality of sections (62, 64, 66) has a partial upper side (12i) which forms, in part, an upper side, all of the partial upper side (12i) of the plurality of sections (62, 64, 66) together form the upper side of the tensioner arm and is backed by a tensioning member such as a spring.

### FIELD OF THE INVENTION

The invention pertains to the field of tensioner arms. More particularly, the invention pertains to flexible tensioner arm with multiple hinges.

### BACKGROUND OF THE INVENTION

Conventional engine timing systems consist of a crankshaft and corresponding sprocket system which operate an engine with either single or dual overhead camshafts. The operation of a conventional engine system is based upon a chain which extends from the crankshaft to the camshaft (or camshafts) and returns to the crankshaft in an endless loop. The movement of the crankshaft and the chain causes the camshaft to rotate. Alternatively, a separate chain can drive between the two camshafts of each bank of cylinders in a dual overhead camshaft engine timing system. Examples of engine timing systems are shown in U.S. Pat. No. 5,427,580, entitled “Phased Chain Assemblies”, which is incorporated herein by reference.

As the chain extends in an endless loop between the driving and the driven sprockets, such as those located on a crankshaft (driving shaft) and camshaft (driven shaft), the chain forms a “tight” side and a “slack” side. The “tight” side is formed by the tension in the span of chain between the links entering the driving sprocket and the links leaving the driven sprocket. A “slack” side is formed on the other span of chain between the links leaving the driving sprocket and entering the driven sprocket.

The performance and action of the chain differs between the tight and slack sides. A chain tensioner is conventionally used on the slack side of the chain. The tensioner acts to take up or eliminate the slack in the chain. As the engine accelerates or decelerates, the tensioner arm may move closer to the chain to maintain the tension, i.e., eliminate the slack in the chain. The tensioner arm typically includes a convex surface to match the path of the chain.

In contrast, a chain guide is conventionally used on the tight side of the chain. Such a guide does not include a tensioner piece, as the chain portion remains tight between the two sprockets. The guide serves to maintain the desired path of the chain between the sprockets.

In the use of the chain tensioner on the slack side of the chain, the tensioner arm is subject to vibrations and forces from the sudden acceleration and deceleration of the engine. Such vibration can cause wear on a tensioner arm surface.

In an automotive engine, a blade-type tensioner has been used as a tensioner to impart tensioning force to an engine timing chain or a drive chain for an auxiliary such as an oil pump and the like. A blade-type tensioner is typically comprised of a blade shoe having an curved chain sliding surface and a leaf-spring-shaped blade spring encased on the opposite side of the chain sliding surface of the blade shoe to apply a spring force to the blade shoe. A proximal end portion of the blade shoe is rotatably supported around a supporting shaft inserted thereinto. A distal end portion of the blade shoe is slidably supported on a supporting surface provided discretely from the blade shoe.

In operation, a chain runs along the chain sliding surface of the blade shoe. A resilient force caused by deformation of the blade shoe and the blade spring presses on the chain, thereby maintaining the chain tensioning force.

FIG. 1 depicts a prior art tensioner arm system with tapered side rails. The illustration shows only a single engine bank of the engine timing system. The engine system consists of a crankshaft 20 and corresponding sprocket 21 and a sprocket 31 mounted on camshaft 30. As explained above, a chain guide may be used with other engine timing systems. The key is to use the chain guide on the tight side of an endless chain.

The engine timing system 10 includes chain 40, chain tensioner system 50, and chain guide 1. The engine chain 40 extends from the crankshaft 20 to the camshaft 30 and returns to the crankshaft 20 in an endless loop. The movement of the crankshaft 20 causes the sprocket 21 to rotate which, in turn, causes sprocket 31 and camshaft 30 to rotate.

The crankshaft sprocket 21 is the driving sprocket and thus the tight side 43 of the chain is formed between the links entering the crankshaft sprocket and leaving the camshaft sprocket 31. The slack side 41 is the opposite side of the chain between the two sprockets 21, 31.

The slack side has a chain tensioner system 50. The tensioning system 50 is designed to maintain the tension on the slack side of the chain. The tight side 43 of the chain 40 has a chain guide 1 to keep the chain in position. The chain guide 1 is positioned so that its upper side 101 is against the underside 42 of the chain 40. The chain 40 is forced into motion by the sprockets 21 and 31, resulting in its movement across or through the groove of the chain guide 1 along a direction of travel of the endless chain.

Blade tensioners have been used in the past to apply tension to chains. An example of a blade tensioner is shown in FIG. 2. The conventional blade tensioner 100 includes a blade shoe 101 made of resin having a curved chain sliding face 101a and numerous blade springs 102 preferably made of metallic material. The blade springs 102 are arranged in layers on the opposite side of blade shoe 101 from chain sliding face 101a, and provide spring force to blade shoe 101. The ends of each spring-shaped blade spring 102 are inserted in the indented portions 111 and 113 which are formed in the distal portion 110 and proximal portion 112 of blade shoe 101, respectively.

A bracket 120 is provided for mounting blade tensioner 100 in an engine. Holes 121 and 122 are formed in bracket 120, and mounting bolts are inserted into these holes 121 and 122. Sliding face 125 contacts the distal portion of blade shoe 101 and permits sliding. Slide face 125 is formed on the distal portion of bracket 120. One end of pin 130, which supports the proximal portion 112 of blade shoe 101 so that it may move in either direction, is secured in the center of bracket 120.

When the chain is operating, the chain continues to slide and run on sliding face 101a of blade shoe 101. The pushing load accompanying the change in the shape of blade shoe 101 and blade springs 102 is applied to the chain so that tension is maintained in the chain. Likewise, the oscillation due to the clattering of the chain and variations in tension are transmitted to the respective blade springs 102 in blade shoe 101 by virtue of blade shoe 101. Each blade spring 102 repeatedly deforms elastically and returns, and the oscillation of the chain is dampened by adjacent blade springs 102 sliding together.

Consideration of information disclosed by the following U.S. Patents, which are all hereby incorporated by reference, is useful when exploring the background of the present invention.

European published patent application EP1036956A2, entitled MECHANICAL CHAIN TENSIONER teaches a tensioner comprises a resin tensioner arm and a torsional coil spring. The tensioner arm is rotatably supported on a bolt that is fixed on the engine block. The torsional coil spring is provided around a flanged bolt fixed on the engine block and biases the tensioner arm in such a way that the tensioner arm swings toward the chain. On the bottom surface of a recessed portion of the tensioner arm is attached a metallic plate 15 that is in contact with the leg portions of the torsional coil spring. No multiple sections or multiple hinges exist herein.

United States issued patent U.S. Pat. No. 5,720,682, entitled TENSIONER ARM AND CHAIN GUIDE WITH PASSAGES FOR OIL DRAINAGE teaches a tensioner arm and a chain guide are constructed with an oil-escape portion, which is designed to allow for the drainage of oil that collects on the back side of the tensioner arm or chain guide. The oil escape portion is comprised of a through-hole on the back side of the tensioner arm or chain guide or through-holes in the side walls located on the back side of the tensioner arm or chain guide. No multiple sections or multiple hinges exist herein.

Japanese published patent application JP8004848A2, entilted TENSIONER ARM AND CHAIN GUIDE TADA NAOZUMI teaches a tensioner arm and a chain guide by which deterioration of properties of engine oil can be prevented. In a tensioner arm 20 for adding tensile force to the timing chain 9 of an engine, through holes 28, 29 are formed on the tension arm, as an oil releasing part for releasing oil to be accumulated in recessed parts 21 on the back surface side of the tensioner arm 20. Thereby oil can be prevented from being accumulated on the back surface of the tensioner arm for a long period of time.

All of the above cited publications have a common characteristic, which is the upper side of tensioner arm such as the blade shoe 101 or the sliding face 101a is formed out of a single piece or member. The present invention teaches a tensioner arm which has an upper side that is formed out of at least two members. It is noted that some tentioner arms have a plastic wear face clipped to an aluminum base. The wear face could be interpreted as “the second member”. However, the present invention does not contemplate the wear face as the second member in that it is contemplated that in addition to the wear face, there still has more than two members in the present invention.

Therefore, it is desirable to have a device that allows rotating (hinged) motion between the at least two members. Additionally, it is desirous to provide the shape of the at least two members which is being supported by some kind of elastic member such as spring at the joint between the members or along the entire tensioner arm.

### SUMMARY OF THE INVENTION

A tensioning device incorporates a plurality of sections of steel members such as stampings that hinge among the plurality of sections is provided A tensioning device incorporates a plurality of sections of molded plastic components that hinge among the plurality of sections is provided.

A tensioner arm incorporates a plurality of sections of steel members such as stampings that hinge among the plurality of sections is provided.

A tensioner arm incorporates a plurality of sections of molded plastic components that hinge among the plurality of sections is provided.

In a tensioner arm, wherein the control of the preload is performed by the hinges of the plurality of sections in which a spring member is placed, and preloaded is controlled via spring stiffness. These hinges are backed by a set of springs that provides force into the chain.

Accordingly, A multi-sectioned tensioner arm (60) is provided. The tensioner arm (60) includes a plurality of sections (62, 64, 66) with each section conjoined together via a binge or joint (68). each of the plurality of sections (62, 64, 66) has a partial upper side (12i) which forms, in part, an upper side, all of the partial upper side (12i) of the plurality of sections (62, 64, 66) together form the upper side of the tensioner arm.

### BRIEF DESCRIPTION OF THE DRAWING

FIG. 1 shows a side view of a prior art power transmission chain and guide system in an engine between the crankshaft and one camshaft.

FIG. 2 shows an example of a prior art blade tensioner.

FIG. 3 shows shows a conjoined tensioner arm of the present invention.

FIG. 4 shows shows a bottom view of the conjoined tensioner arm of the present invention.

FIG. 5 shows a top view of the conjoined tensioner arm of the present invention.

FIG. 6 shows a computer model picture of the compliant arm with joints in place.

FIG. 7 shows a top perspective view of the conjoined tensioner arm of the present invention.

FIG. 8 shows a bottom perspective view of the conjoined tensioner arm of the present invention.

### DESCRIPTION OF THE PREFERRED EMBODIMENT

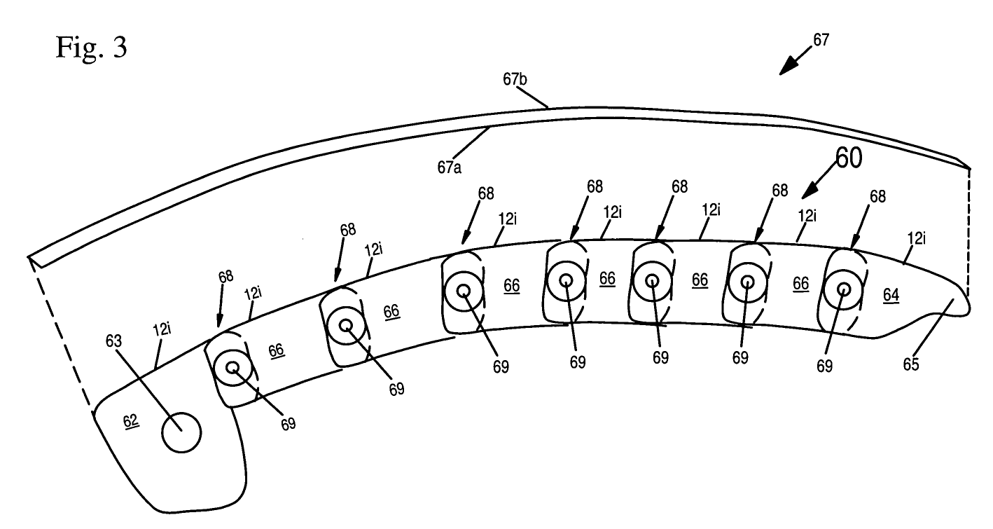

In a chain drive such as an internal combustion timing chain drive, the present invention comprises a tensioner arm incorporating a plurality of sections of steel members such as stampings or molded plastic components that hinge among the plurality of sections. FIGS. 3-5 depict a set of conceptual views of the present invention.

Referring to FIG. 3, a conjoined tensioner arm 60 of the present invention is shown. Tensioner arm 60 has a first end section 62 and a second end section 64. First end section 62 has an annular opening 63 for receiving a bolt (not shown) such as a shoulder bolt for allowing pivoting to occur. Second end section 64 has an elongated end 65. which comforms to the shape of some known tensioner arm. This way, an allowance for translational movement exists for the tensioner arm due to the physical shape of the elongated end 65 thereby tensioner arm 60 as a whole may adjust itself somewhat given the physical shape of the elongated end 65. Tensioner arm 60 may have at least one intermediate section 66. Or typically, tensioner arm 60 may have a plurality of intermediate sections 66. It is noted that the present invention includes the possibility of having only two sections conjoined together. For example, conjoined tensioner arm 60 may only consisted of first end section 62 and second end section 64 conjoined together with no intermediate section 66 interposed therebetween.

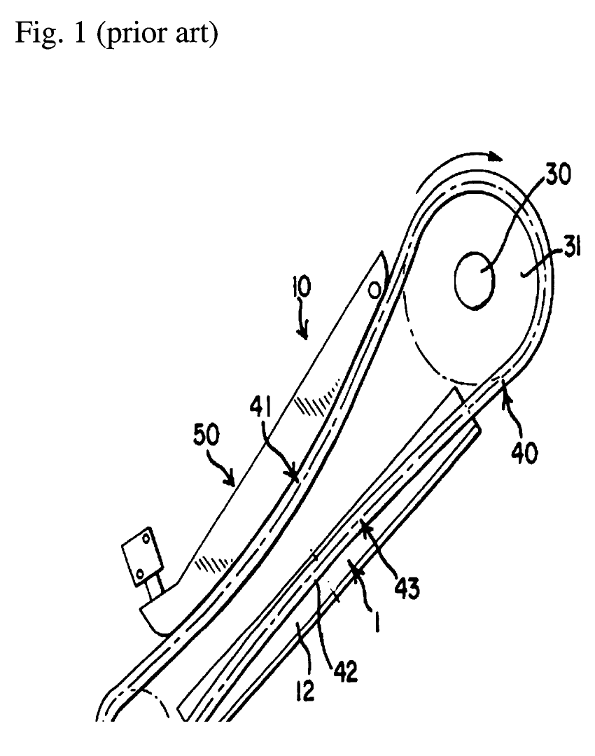

Each section 62, 64, 66 may be made out of steel stampings. Alternatively, sections 62, 64, 66 may be made out of molded plastic components. The sections 62, 64, 66 are connected via hinges 68 or torsional springs. A pin 69 is positioned as the actual hinge to conjoined sections 62, 64, 66. Each section of the sections 62, 64, 66 has a partial upper side 12i, where i is a positive integer, i.e. 1, 2, . . . i . . . n. All the partial upper side, Σ12i together form the upper side of the conjoined tensioner arm 60 such as the upper surface 101 in FIG. 1. In other words, the conjoined tensioner arm of a plurality of sections together forms an equivalent of a prior art upper surface. One distinguishing point of the present invention with that of the prior art is that a number of sections or at least two sections are conjoined to form a tensioner arm. Having different sections is not a feature of the prior art of tensioner arms where only a single member serves the purpose of multiple members of the present invention. A second distinguishing factor is that tension can be provided in hinge mechanism to maintain curved shape.

For sections that are made out of steel stampings, a molded plastic face 67 or shoe is typically required to cover the combination of all partial upper sides, Σ12i. The face typically consists of a single member.

In other words, a flexible tensioner arm 60 is shown. Tensioner arm 60 has multiple hinges 68. Tensioner arm 60 include multiple unit members including a first end pivotal section 62, a second end section 64, and at least one middle section 66. Alternatively, there may be no middle section 66 at all in that first end pivotal section 62 and second end section 64 are connected together forming the only members of the tentioner arm 60. Sections 62, 64, 66 can be made out of a number of materials including steel stampings or molded plastic components. Sections 62, 64, 66 are interconnected by hinges 68. Sections 62 has a connecting pivotal element such as an opening 63 pivotally connected to a third member (not shown) for anchoring tensioner arm 60. An overlaying member 67 or face overlays the flexible tensioner arm 60. Overlaying member 67 has an inside surface 67a that may be in contact with a surface of tensioner arm 60 free of chemical bonding. Overlaying member 67 further has an outside surface 67b in contact with a chain (not shown). It is noted that there may be relative movement between inside surface 67a and the surface of tensioner arm 60.

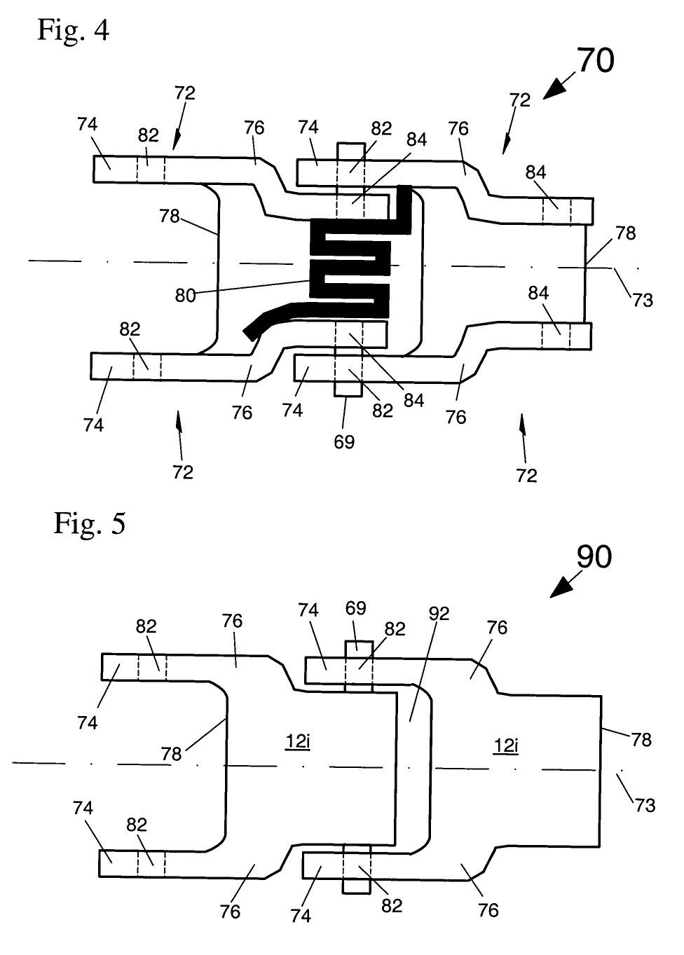

Referring to FIG. 4, a bottom view of the link 68 linking two adjacent sections 66 is shown. Note that the link 68 between section 66 and first end section 62, or between section 66 and second end section 64 are identical. The difference is in the physical shape of the sections individually, but the link is identical. Similarly, first end section 62 and second end section 64 may be linked together by a link that is identical to link 68.

Each section 66 has a pair of ridges 72. Each ridge 72 forms a lateral side of section 66 and is the outer limit of the lateral side. One ridge 72 is symmetrical to the other in relation to a center line 73 along the travel of an endless chain (not shown). Section 66 has two legs 74 each forming an extension of each of the pair of ridges 72. On each leg 74, an annular aperture is formed thereon for receiving pin 69. Each ridge 72 has curved band portion 76 which results in a narrower portion of section 66 to thereby accommodate the linking of one section to its adjacent section.

A continuum 78 that is part of section 66 is formed between ridges 72. Continuum 78, together with the pair of ridges 72 defines a three dimensional space for accommodating or the placing of a link element such as a spring 80. The spring 80 may be a solid or a wound torsion, helical, leaf, or similar type of spring that provides force to maintain a desired shape. This desired shape is maintained due to the “compliant” nature of the guide. A tensioner arm is compliant when it somewhat accommodate a chain which exerts a tensioning force upon the arm. More specifically, with regard to the three dimensional space, only part of the pair of ridges 72 together with a first surface of continuum 78 defines the space. The part of the pair of ridges 72 includes part of lags 74, and the rest of the ridges 72 including the curved bands 76.

On the pair of ridges 72 there are two pairs of apertures for receiving pin 69 per pair of aperture. The two pairs of apertures include a first pair of aperture 82 which is formed on lags 74, and a second pair 84 formed on the opposite end of the ridge 72 in relation to the lags 74. Aperture 82 may be round in shape.

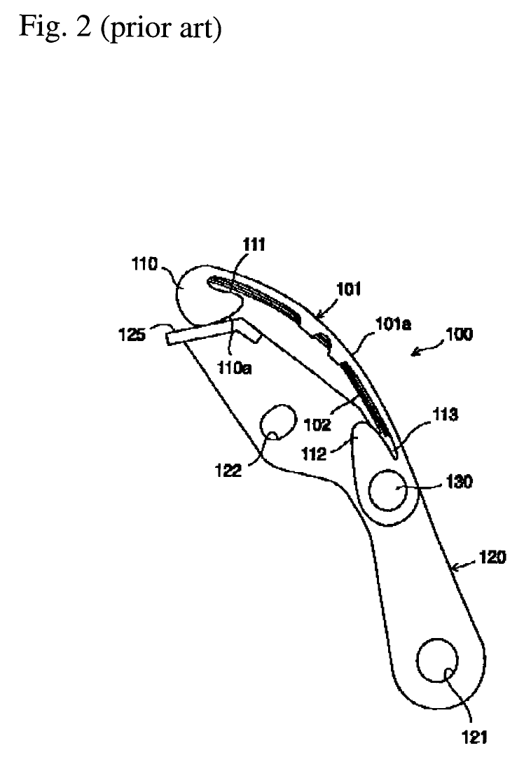

Referring to FIG. 5, a top view of a top view of the conjoined tensioner arm 68 is shown. A second surface 12i is formed as the opposite surface of the first surface of continuum 78. Second surface 12i is more extensive than the opposite first surface of continuum 78 since second surface 12i extents over the pair of ridges 72. Ideally each second surface 12i forms a continuous surface such as surface 101 of FIG. 2. However, in practice, there may be a gap 92 which exists between adjacent second surfaces 12i. Preferably gap 92 should be formed as narrow as that which is practical. However, there may be advantages of having a suitable gap such that lubricating fluid may flow through it.

The physical shape of the first end section 62 and second end section 64 can be of any suitable shape or formation known to the art of tensioner arm. Typically, the shape is identical to the relevant section of a known single member tensioner arm.

Chain drive applications usually require a tensioning device to maintain chain tension. The tensioning device incorporates multiple sections of steel stampings or molded plastic components that hinge. These hinges are backed by a spring that provides force into the chain. The advantage of the flexible tensioner arm with multiple hinges is a modular low cost design and control of the preload via spring stiffness.

This device incorporates multiple sections of steel stampings or molded plastic componentes that hinge. Those hinges are integrated with a solid or wound torsion spring, helical spring, leaf spring, or other similar spring that provides force into the chain. Stamped steel components would require an additional plastic wear surface, possibly plastic or an elastomer which would be held to the steel base by a slot, a series of clips, or a similar method. Plastic molded components may not require a wear surface. One section of the arm provides a pivot function and is different from the center modular sections. The end section has a sliding contact interface with a surface on the engine block. The advantage of the flexible tensioner arm with multiple hinges is a modular low cost design and control of the preload via spring stiffness.

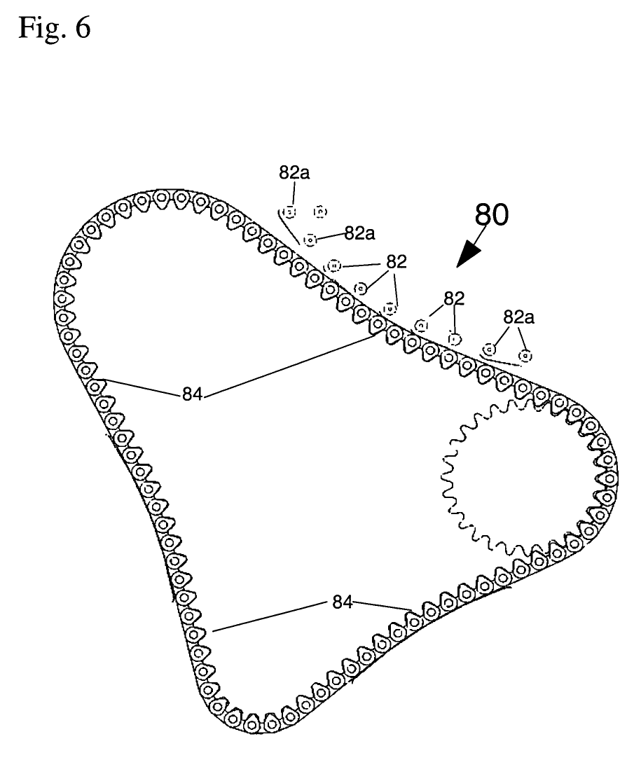

Referring to FIG. 6, a computer model picture of the compliant arm 80 with joints 82 in place is shown. Note that some joints 82a are not touching the chain 84.

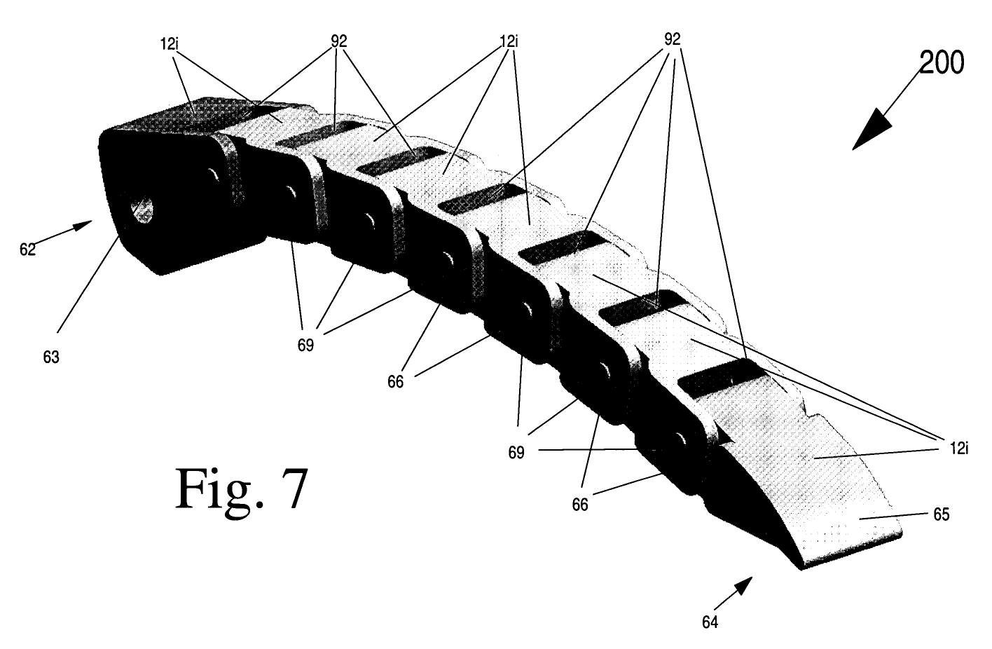

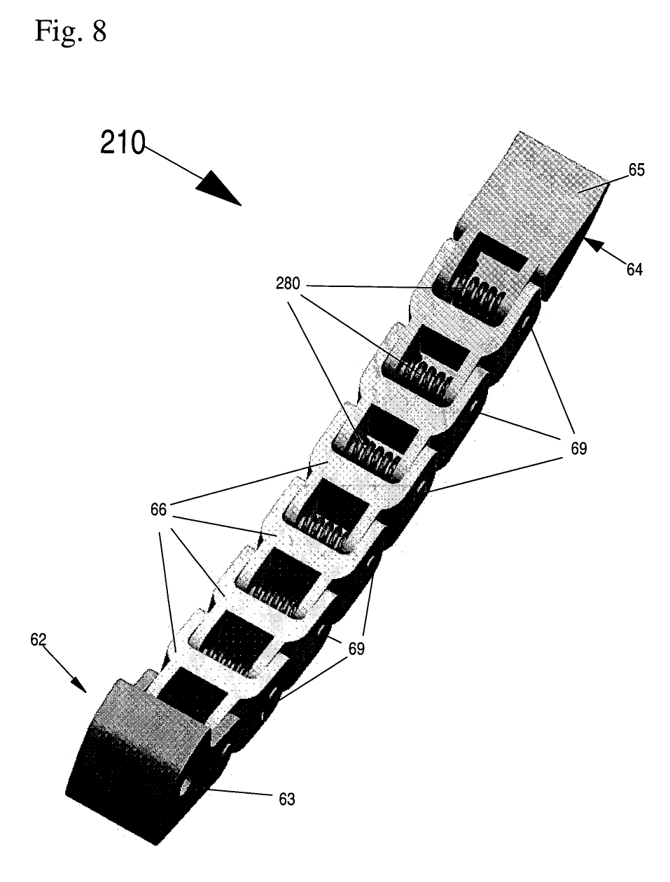

Referring to FIGS. 7 and 8, two perspective views of the present invention are shown. Referring specifically to FIG. 7, a top perspective view 200 of an embodiment of the present invention is shown. Sections 62, 64, and 66 are conjoined together pin 69. Each of the sections provides a partial upper sides 12i which forms the whole upper side Σ12i. gaps 92 may exist between the partial upper sides 12i. elongated end 65 forms an extension of section 64. annular opening 63 is formed on section 62.

Referring specifically to FIG. 8, a bottom perspective view 210 of the present invention is shown. Other than the corresponding elements or members shown in FIG. 7, note the torsional spring 280 fitted in each and every link of the conjoined tensioner arm.

Accordingly, it is to be understood that the embodiments of the invention herein described are merely illustrative of the application of the principles of the invention. Reference herein to details of the illustrated embodiments are not intended to limit the scope of the claims, which themselves recite those features regarded as essential to the invention.

1. A tensioner arm (60) comprising:
a plurality of sections (62, 64, 66) with each section conjoined together via a link (68);
each of the plurality of sections (62, 64, 66) having a partial upper side (12i) which forms, in part, an upper side, all of the partial upper side (12i) of the plurality of sections (62, 64, 66) together form the upper side of the tensioner arm.

2. The tensioner arm of claim further comprising a link disposed to link two adjacent sections of the plurality of sections (62, 64, 66) together.

3. The tensioner arm of claim 2, wherein the link comprises a pin (69) disposed to pass through annular openings of adjacent sections.

4. The tensioner arm of claim 3, wherein the link comprises an elastic member (280) associated with the pin (69) to maintain shape and compliance with use.

5. The tensioner arm of claim 1, wherein the plurality of sections (62, 64, 66) consists of a first end section (62).

6. The tensioner arm of claim 1, wherein the plurality of sections (62, 64, 66) consists of a second end section (64).
